(19) United States
(12) Patent Application Publication
(10) Pub. No.: US 2025/0199143 A1
(43) Pub. Date: Jun. 19, 2025

(54) LIDAR WITH FOCAL PLANE ARRAY

(71) Applicant: University of Southern California, Los Angeles, CA (US)

(72) Inventor: Hossein Hashemi, Los Angeles, CA (US)

(21) Appl. No.: 18/980,954

(22) Filed: Dec. 13, 2024

Related U.S. Application Data
(60) Provisional application No. 63/610,111, filed on Dec. 14, 2023.

(51) Int. Cl. G01S 7/4915; G01S 7/481; G01S 7/4911; G01S 7/4914

(52) U.S. Cl. CPC G01S 7/4915; G01S 7/4811; G01S 7/4911; G01S 7/4914

(57) ABSTRACT

A Light Detection and Ranging (LIDAR) system includes a transmitter configured to transmit a frequency modulated continuous wave (FMCW) signal to an environment of the LIDAR system, a receiver configured to receive, from a target in the environment, a return signal in response to transmitting the FMCW signal, a focal plane array (FPA) coupled to at least one of the transmitter and the receiver, the FPA including a two-dimensional array of pixels, and a circuit included in the FPA and configured to control each of the two-dimensional array of pixels to at least one of: (i) transmit the FMCW signal to the environment through the two-dimensional array of pixels and (ii) receive the return signal through the two-dimensional array of pixels.

### CROSS-REFERENCE TO RELATED PATENT APPLICATIONS

This application claims priority to and the benefit of U.S. Provisional Application No. 63/610,111, filed Dec. 14, 2023, entitled “Focal Plane Array Silicon Photonics Coherent LIDAR with In-Pixel Processing,” which is incorporated herein by reference in its entirety for all purposes.

### BACKGROUND

The following description is provided to assist the understanding of the reader. None of the information provided or references cited is admitted to be prior art.

Light Detection and Ranging (LIDAR) is important for numerous applications in self-driving cars, drones, robots, etc. For example, LIDAR is widely used in true self-driving vehicles. Additionally, compact, low-power LIDAR enables the creation of 3D point clouds, greatly enhancing Virtual Reality (VR), Mixed Reality (MR), Augmented Reality (AR), etc. Over the past few years, significant research has reduced the size, cost, and power consumption of LIDAR systems. There has also been substantial improvement in supporting signal processing, image recognition, and reconstruction algorithms, as well as associated hardware.

LIDAR utilizes photonics technology, such as laser light to measure distances and capture detailed data by transmitting and receiving signals. The photonic components in LIDAR systems, including lasers, detectors, and sensors, enable the precise measurement and imaging, making LIDAR effective for applications like mapping, autonomous vehicles, and environmental monitoring.

### SUMMARY

Certain embodiments of the present disclosure relate to LIDAR with focal plane array.

An aspect of the disclosure is directed to a Light Detection and Ranging (LIDAR) system. The LIDAR system includes a transmitter configured to transmit a frequency modulated continuous wave (FMCW) signal, a receiver configured to receive, from a target, a return signal in response to transmitting the FMCW signal, a focal plane array (FPA) coupled to at least one of the transmitter and the receiver, the FPA including a two-dimensional array of pixels, and a circuit included in the FPA and configured to control each of the two-dimensional array of pixels to at least one of: (i) transmit the FMCW signal through the two-dimensional array of pixels and (ii) receive the return signal through the two-dimensional array of pixels.

In some embodiments, the circuit includes a plurality of in-processing circuits, each of which is included in a corresponding one of the two-dimensional array of pixels. In some embodiments, each of the in-processing circuits includes a receiver circuit including a transimpedance amplifier (TIA), an analog-to-digital converter (ADC), and a Fourier Transform engine. In some embodiments, each of the two-dimensional array of pixels includes an optical switch configured to activate a corresponding one of the two-dimensional array of pixels to transmit the FMCW signal or to receive the return signal. In some embodiments, the optical switch includes a micro-ring resonator. Each of the in-processing circuits includes control circuitry configured to set a resonance wavelength of the optical switch. In some embodiments, the FPA is integrated within a semiconductor substrate and operatively coupled with Complementary Metal-Oxide-Semiconductor (CMOS) circuits, the CMOS circuits configured to realize the plurality of in-processing circuits to control the corresponding one of the two-dimensional array of pixels. The FPA is configured to transmit the FMCW signal or receive the return signal through a front side or a back side of the semiconductor substrate. In some embodiments, the FPA is configured to transmit the FMCW signal or receive the return signal through the front side of the semiconductor substrate. The CMOS circuits are operatively coupled to the pixels through respective via structures extending in a thickness direction of the semiconductor substrate. In some embodiments, the FPA is configured to transmit the FMCW signal or receive the return signal through the back side of the semiconductor substrate. Each of the plurality of pixels includes a grating coupler, a photodetector, and a reflector configured to reflect light toward the back side of the semiconductor substrate. In some embodiments, the LIDAR system includes one or more processors configured to control the circuit for the transmitter to transmit the FMCW signal through selected one or more pixels of the FPA, and control the circuit for the receiver to receive the return signal through the selected one or more pixels of the FPA. In some embodiments, the LIDAR system includes an optic configured to couple the FPA to the transmitter when the LIDAR system transmits the FMCW signal and couple the FPA to the receiver when the LIDAR system receives the return signal. In some embodiments, the one or more processors are configured to select one or more pixels of the two-dimensional array of pixels, and the circuit is configured to selectively activate the selected one or more pixels to transmit the FMCW signal or receive the return signal. In some embodiments, the one or more processors are configured to select the one or more pixels based on a machine learning model that provides an output indicating which pixels operate at a given time. In some embodiments, each of the two-dimensional array of pixels includes a plurality of sub-pixels, each of which including a light coupler configured to transmit the FMCW signal or receive the return signal. The circuit includes a plurality of in-processing circuits, each of which is included in a corresponding one of the two-dimensional array of pixels and configured to control the plurality of sub-pixels included in the corresponding one of the two-dimensional array of pixels. In some embodiments, the LIDAR system includes an optical switch configured to select the plurality of sub-pixels.

Another aspect of the disclosure is directed to a Light Detection and Ranging (LIDAR) system. The LIDAR system includes a transmitter configured to transmit an optical signal, a receiver configured to receive, from a target, a return signal in response to transmitting the optical signal, a focal plane array (FPA) configured to selectively couple with the transmitter or the receiver through an optic, and one or more processors configured to control the optic to couple the FPA to the transmitter when the LIDAR system transmits the optical signal, and to couple the FPA to the receiver when the LIDAR system receives the return signal.

In some embodiments, the LIDAR system includes a plurality of in-processing circuits, each of which is included in a corresponding one of a plurality of pixels of the FPA. The one or more processors are configured to control each of the plurality of in-processing circuits to control the corresponding one of the plurality of pixels of the FPA to transmit the optical signal or receive the return signal. In some embodiments, the FPA is integrated within a semiconductor substrate, and the semiconductor substrate is connected to a Complementary Metal-Oxide-Semiconductor (CMOS) circuit through one or more bump structures. In some embodiments, the semiconductor substrate includes a microlens on a front side or a back side of the substrate, and the FPA is configured to transmit the optical signal or receive the return signal through the microlens. In some embodiments, the optical signal is a frequency modulated continuous wave (FMCW).

Another aspect of the disclosure is directed to a method for Light Detection and Ranging (LIDAR). The method includes selectively coupling, by an optic, a focal plane array (FPA) to a transmitter or a receiver, the FPA including a plurality of pixels, each of which includes a corresponding one of a plurality of in-processing circuits, controlling at least one of the plurality of in-processing circuits in the FPA, and in response to controlling the at least one of the plurality of in-processing circuits, at least one of: (i) transmitting, by the transmitter, an optical signal to an environment of a LIDAR system, and (ii) receiving, by the receiver, from a target in the environment, a return signal.

In some embodiments, the method includes coupling the optic to the transmitter, setting a resonance wavelength of an optical switch of the FPA, and transmitting, by the transmitter, the optical signal based on the resonance wavelength of the optical switch. In some embodiments, the method includes coupling the optic to the receiver, receiving, by the receiver, the return signal, and processing, by at least one of the plurality of in-processing circuits, the return signal, in response to receiving the return signal.

Various aspects, embodiments, advantages, etc. of the present disclosure, as well as details of illustrated embodiments thereof, will be more understood from the following description and drawings.

### BRIEF DESCRIPTION OF THE DRAWINGS

The drawings are of illustrative embodiments. They do not illustrate all embodiments. Other embodiments can be used in addition or instead. Details that can be apparent or unnecessary can be omitted to save space or for more effective illustration. Some embodiments can be practiced with additional components or steps and/or without all of the components or steps that are illustrated. When the same numeral appears in different drawings, it refers to the same or like components or steps.

FIG. 1 illustrates a block diagram of an example LIDAR system, in accordance with various embodiments.

FIG. 2 illustrates a block diagram of an example LIDAR system, in accordance with various embodiments.

FIG. 3 illustrates a block diagram of an example LIDAR system, in accordance with various embodiments.

FIG. 4 illustrates a schematic diagram of an example FPA that can be included in a LIDAR system, in accordance with various embodiments.

FIG. 5 illustrates a block diagram of an example LIDAR system, in accordance with various embodiments.

FIG. 6A illustrates a schematic diagram of an example transmitter that can be included in a LIDAR system, in accordance with various embodiments.

FIG. 6B illustrates a schematic diagram of an example receiver that can be included in a LIDAR system, in accordance with various embodiments.

FIG. 7 illustrates a schematic diagram of an example receiver that can be included in a LIDAR system, in accordance with various embodiments.

FIG. 8 illustrates a schematic diagram of an example LIDAR system, in accordance with various embodiments.

FIG. 9 illustrates a block diagram of an example LIDAR system, in accordance with various embodiments.

FIG. 10 illustrates a schematic diagram of an example FPA that can be included in a LIDAR system, in accordance with various embodiments.

FIG. 11A illustrates a schematic diagram of an example LIDAR system, in accordance with various embodiments.

FIG. 11B illustrates a schematic diagram of an example LIDAR system, in accordance with various embodiments.

FIG. 12 illustrates a flow chart of an example method for LIDAR, in accordance with various embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Recent advancements in LIDAR technology have focused on reducing the size, cost, and energy consumption of LIDAR systems while enhancing capabilities in signal processing, image analysis, reconstruction algorithms, and supporting hardware. One development involves utilizing photonics technology to measure distances and gather detailed data by transmitting and receiving laser signals. Among various LIDAR approaches, frequency-modulated continuous wave (FMCW) coherent detection offers various advantages, including improved signal-to-noise ratio (SNR), elimination of high-power short pulses, and greater robustness against interference.

Despite its potential, LIDAR technology faces several challenges, including restricted beam steering in optical phased array (OPA), complex calibration under varying temperature and process conditions, and significant optical losses. OPAs offer electronically controlled beam steering but have not yet demonstrated a wide two-dimensional field of view, and calibration challenges continue to limit their practical application. Techniques disclosed herein combine FMCW coherent detection with focal plane arrays (FPAs) that include a circuit (e.g., a control circuit, an in-processing circuit, etc.). FPAs offer several advantages, including a wide two-dimensional field of view, operation without the need for calibration, and reduced optical loss. By integrating photonics and electronics, this approach enables in-pixel processing, compact low-loss optical components, energy-efficient circuitry, and advanced 3D integrated circuit (IC) stacking technologies. Furthermore, this approach leverages the strengths of silicon photonics to develop a high-performance coherent FPA LIDAR operating at a 1550 nm wavelength. This configuration provides several advantages, including extended range for a given laser power, increased depth accuracy, reduced sensitivity to ambient light and interference, and a broader field of view compared to existing solutions. Additionally, it reduces costs and physical footprint, making it a promising candidate for high-volume applications. The use of commercial silicon photonics foundries further enables the manufacturing of chip-scale, high-resolution LIDAR systems.

Illustrative embodiments are now described. Other embodiments can be used in addition or instead. Details that can be apparent to a person of ordinary skill in the art can have been omitted. Some embodiments can be practiced with additional components or steps and/or without all of the components or steps that are described.

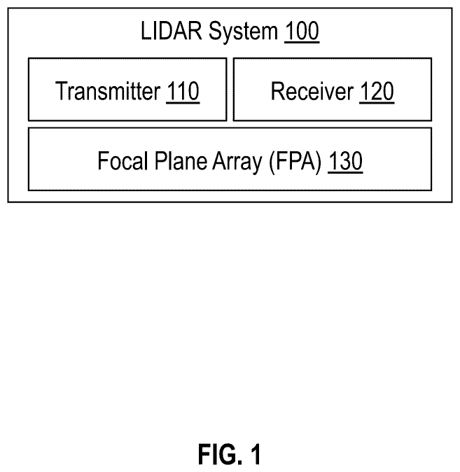

FIG. 1 illustrates a block diagram of an example LIDAR system 100, in accordance with various embodiments. The LIDAR system 100 of FIG. 1 is simplified for illustrative purposes, and thus, can be implemented as any of various other configurations while remaining within the scope of the present disclosure. In some examples, the LIDAR system 100 can include more, fewer, or different components than shown in the figure.

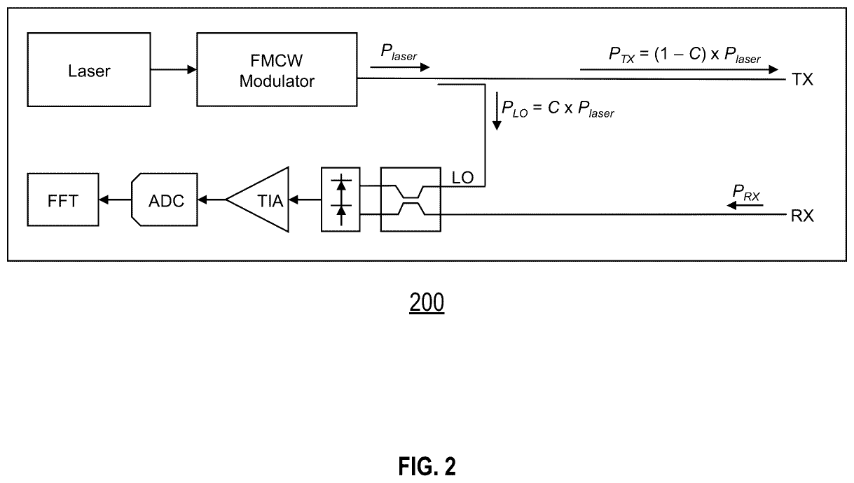

In some embodiments, the LIDAR system 100 can use frequency modulation to encode an optical signal and transmit the encoded optical signal into an environment of the LIDAR system 100 using optics. By detecting frequency differences between the encoded optical signal and a return signal reflected back from a target in the environment, the frequency modulated (FM) LIDAR system can determine a location of the target and/or measure a velocity of the target (e.g., using the Doppler effect). In some embodiments, the LIDAR system 100 can operate using a FM continuous wave (CW) (sometimes referred to as, “FMCW”). FIG. 2 illustrates a block diagram of an example LIDAR system 200, in accordance with various embodiments. In some embodiments, the LIDAR system 200 can be an example of the LIDAR system 100 implemented as a FMCW LIDAR.

Referring to FIG. 2, the LIDAR system 200 includes a transmitter including and/or operatively coupled with a laser, a FMCW modulator, etc. The LIDAR system 200 includes a receiver including and/or operatively coupled with a photodetector, a transimpedance amplifier (TIA), an analog-to-digital converter (ADC), a Fast Fourier Transform (FFT) engine, etc. Although not shown, the LIDAR system 200 includes various optics (e.g., lens, etc.) to control (e.g., transmit, receive, etc.) light signals. The LIDAR system 200 of FIG. 2 is simplified for illustrative purposes, and thus, can be implemented as any of various other configurations while remaining within the scope of the present disclosure. In some examples, the LIDAR system 200 can include more, fewer, or different components than shown in the figure.

In an FMCW operation of the LIDAR system 200, a fraction of a laser power Plaser can be transmitted to an environment of the LIDAR system 200, and the rest can be provided as a local oscillator (LO) to a coherent receiver. This can be expressed as:

$$\{ \begin{matrix}{P}_{LO} = C \times {P}_{laser} \\ {P}_{TX} = ( 1 - C ) \times {P}_{lase r}\end{matrix} ,$$

where C is the fraction of the laser power used as the LO in the receiver. The power of the received signal from a Lambertian reflector at a distance r can be given by:

$${P}_{R X} = {P}_{TX} ρ \frac{1}{π {r}^{{}_{2}}} {A}_{RX} ,$$

where P_{RX} is a transmitted signal power, ρ is a reflectivity of a target in the environment, and A_{RX} is a total area of a collecting aperture.

As discussed above, FMCW coherent detection allows LIDAR systems (e.g., the LIDAR systems 100, 200, etc.) to operate with improved signal-to-noise ratio (SNR), elimination of high-power short pulses, and greater robustness against interference.

Referring to FIG. 1, the LIDAR system 100 includes a transmitter 110, a receiver 120, a focal plane array (FPA) 130, etc. The transmitter 110 can be configured to transmit an optical signal to an environment of the LIDAR system 100. In some embodiments, the transmitter 110 can be configured to transmit a FMCW signal to the environment of the LIDAR system 100. For example, the LIDAR system 100 includes a FMCW modulator (e.g., as shown in FIG. 2) configured to modulate the optical signal for FMCW operation, and the transmitter 110 can transmit the FMCW signal to the environment. The receiver 120 can be configured to receive, from a target in the environment, a return signal in response to transmitting the optical signal. In some embodiments, the receiver 120 can be configured to receive the return signal in response to transmitting the optical signal being a FMCW signal.

The FPA 130 of the LIDAR system 100 can be operatively coupled with at least one of the transmitter 110 and the receiver 120. In some embodiments, the transmitter 110 can transmit the FMCW signal through the FPA 130. In some embodiments, the receiver 120 can receive the return signal through the FPA 130. The FPA 130 includes a plurality of pixels configured to transmit and/or receive optical signals. In some embodiments, the FPA 130 can include a two-dimensional array of pixels. In some embodiments, the transmitter 110 can transmit the FMCW signal through the plurality of pixels (e.g., the two-dimensional array of pixels). In some embodiments, the receiver 120 can receive the return signal through the plurality of pixels (e.g., the two-dimensional array of pixels). In some embodiments, as discussed in greater detail below, the FPA 130 can include a circuit (not shown). In some embodiments, the circuit is included in a substrate of the FPA 130. In some embodiments, the circuit (e.g., an in-processing circuit) is included in each of the plurality of pixels. The circuit can be configured to control each of the plurality of pixels (e.g., the two-dimensional array of pixels) to transmit the FMCW signal to the environment through a corresponding one of the plurality of pixels and receive the return signal from the target in the environment through the corresponding one of the plurality of pixels.

As discussed below, the circuit (e.g., the in-processing circuit, etc.) can be used to perform various operations of a LIDAR system. In some embodiments, an FPA can include a plurality of in-processing circuits included in each of a plurality of pixels of the FPA and can be configured to control a corresponding one of the plurality of pixels of the FPA. For example, the in-processing circuit can be configured to control the corresponding pixel to transmit the FMCW signal or receive the return signal. With the foregoing in mind, the figures and description below illustrate examples of the LIDAR systems including the FPA with the circuit. Although some FPAs are shown to omit the circuit (e.g., the in-processing circuit), it should be understood that the FPAs can include one or more circuits (e.g., one or more in-processing circuits) to perform various operations described below. It should be noted that the figures and description below are non-limiting examples and can be implemented as any of various other configurations while remaining within the scope of the present disclosure.

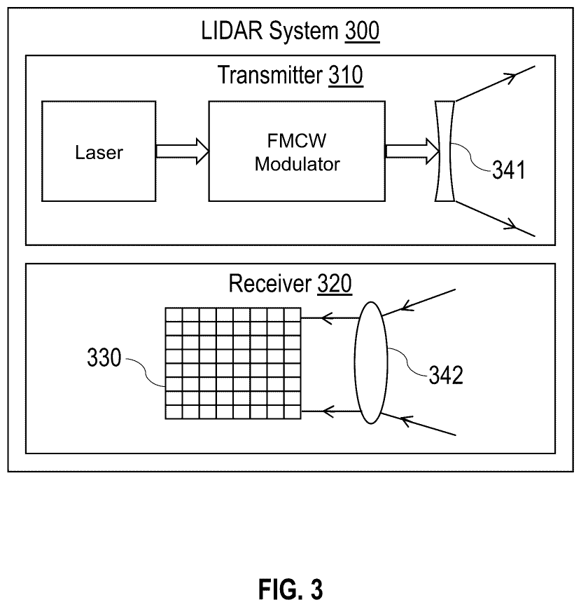

FIG. 3 illustrates a block diagram of an example LIDAR system 300, in accordance with various embodiments. In some embodiments, the LIDAR system 300 may be substantially similar to or incorporate features of the LIDAR system 100. For example, the LIDAR system 300 includes a transmitter 310, a receiver 320, and a FPA 330, which may be substantially similar to or incorporate features of the transmitter 110, the receiver 120, and the FPA 130. The LIDAR system 300 of FIG. 3 is simplified for illustrative purposes, and thus, can be implemented as any of various other configurations while remaining within the scope of the present disclosure. In some examples, the LIDAR system 300 can include more, fewer, or different components than shown in the figure.

In some embodiments, the FPA 330 can be included in and/or operatively coupled with the receiver 320. The transmitter 310 can transmit an optical signal to an environment of the LIDAR system 300. For example, a FMCW modulator of the transmitter 310 can receive an input signal from a laser source and configure the input signal for FMCW operation. The transmitter 310 can transmit the FMCW signal to the environment of the LIDAR system 300. In some embodiments, the transmitter 310 can transmit the optical signal to the environment through a first lens 341. In some embodiments, the transmitter 310 can be a FMCW flash illuminator. In some embodiments, the transmitter 310 can be configured to illuminate an entire scene of the environment of the LIDAR system 300. The receiver 320 can receive a return signal from a target in the environment in response to transmitting the optical signal. The FPA 330 of the receiver 320 can be configured to receive the return signal. For example, each of a plurality of pixels in the FPA 330 can receive a corresponding portion of the return signal. In some embodiments, the receiver 320 can receive the return signal from the target in the environment through a second lens 342. Although not shown, in some embodiments, the FPA 330 can be included in and/or operatively coupled with the transmitter 310.

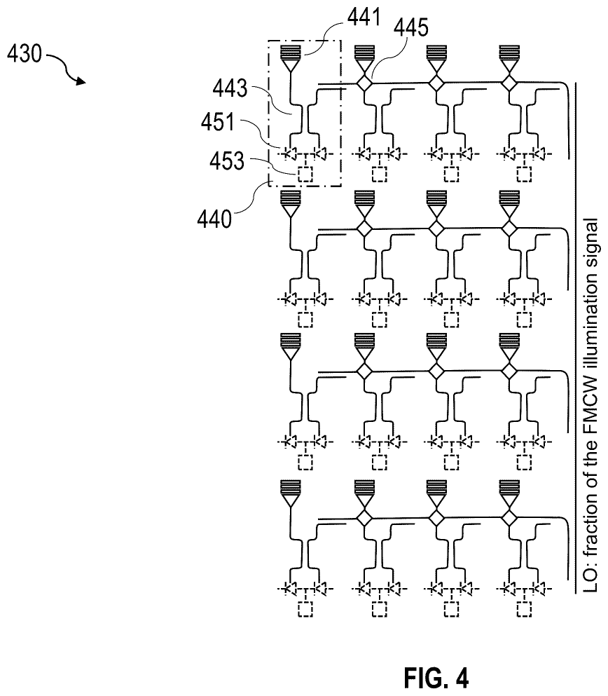

FIG. 4 illustrates a schematic diagram of an example FPA 430 that can be included in a LIDAR system (e.g., the LIDAR systems 100, 200, 300, etc.), in accordance with various embodiments. In some embodiments, the FPA 430 may be substantially similar to or incorporate features of the FPA 130, 330, etc. The FPA 430 of FIG. 4 is simplified for illustrative purposes, and thus, can be implemented as any of various other configurations while remaining within the scope of the present disclosure. In some examples, the FPA 430 can include more, fewer, or different components than shown in the figure.

In some embodiments, the FPA 430 may be included in and/or operatively coupled to a receiver (e.g., the receivers 120, 320, etc.). For example, the FPA 430 may be an example of the FPA 330. In some embodiments, the FPA 430 can be included in the receiver through a system-in-package (SIP). For example, the FPA 430 can be integrated within a coherent FPA SiP receiver, a silicon substrate, a photonic integrated circuit, etc.

The FPA 430 is shown to include a plurality of pixels 440. In some embodiments, the plurality of pixels 440 can form a two-dimensional array of pixels, as shown. Although not shown, the plurality of pixels 440 can be arranged in various manners without departing from the scope and spirit of the disclosure. For example, the plurality of pixels 440 can form a 64 by 64 array, a 128 by 64 array, etc.

In some embodiments, each of the pixels 440 can include a light coupler 441. In some embodiments, the light coupler 441 can be a grating coupler or any structure configured to couple light between different optical media (e.g., converting between free-space and waveguide modes). For example, the light coupler 441 can be configured as a light collector to receive a return signal. This allows for precise manipulation and detection of the light signals over a broad range of angles and wavelengths. In some embodiments, the light coupler 441 can include or be operatively coupled with a microlens, a waveguide, an aperture, a free-space optics, a nanostructure, etc. The FPA 430 can be configured to receive a return light through the light coupler 441. In some embodiments, the FPA 430 can include various optics configured to control (e.g., direct, transmit, split, combine, etc.) light signals, including but not limited to, a hybrid coupler 443, a waveguide crossing 445, etc.

In some examples, each of the pixels 440 can include a circuit (e.g., a control circuit, an in-processing circuit, etc.). For example, each of the pixels 440 can include a photodetector (e.g., a balanced photodetector) 451 and a receiver circuit (or electronics) 453 configured to control the return signal (e.g., received through the light coupler 441). For example, the photodetector 451 can receive the return signal and convert into an electrical signal. The receiver circuit 453 can receive and process the electrical signal. In some embodiments, the receiver circuit 453 can include a transimpedance amplifier (TIA), an analog-to-digital converter (ADC), a Fourier Transform engine (e.g., a Fast Fourier Transform (FFT) engine), etc. The receiver circuit 453, including the TIA, ADC, FFT, etc. coupled within each of the pixels 440, allows for concurrent operation of the pixels 440 while utilizing all the transmitted optical power and achieving an increased frame rate. In some embodiments, at least one component of the FPA 430, for example, the receiver circuit 453, can be integrated using 3D stacking in a Complementary Metal-Oxide-Semiconductor (CMOS) circuit/chip with a Si photonic integrated circuit (PIC).

In some embodiments, each of the pixels 440 may include more, fewer, or different components than shown in the figure. For example, each of the pixels 400 may omit the photodetector 451, the receiver circuit 453, etc., and instead can be operatively coupled with the photodetector 451, the receiver circuit 453, etc. located outside the FPA 430.

In some embodiments, the FPA 430 can include and/or operatively coupled with a primary lens (e.g., the second lens 342) configured to collect the return signal and allow the return signal to reach the FPA 430. Here, the FPA 430 can be configured as a coherent FPA receiver silicon photonic integrated circuit (Si PIC). In some embodiments, each of the pixels 440 can include a microlens configured to receive a corresponding portion of the return signal. This can improve the fill-factor.

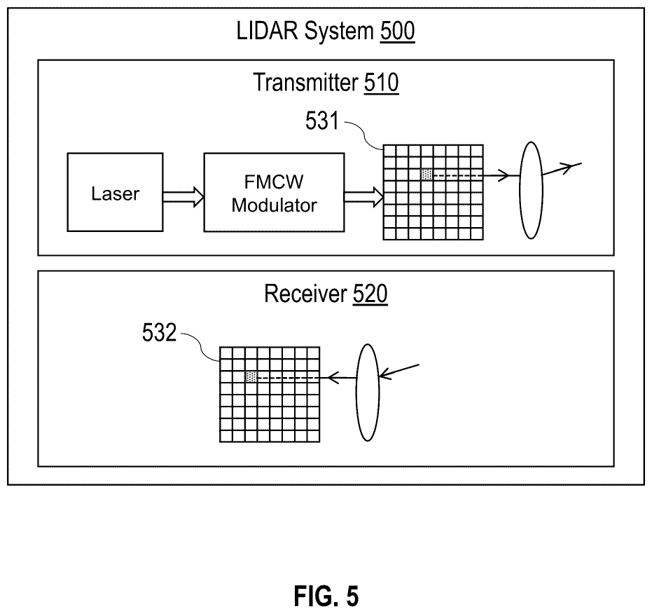

FIG. 5 illustrates a block diagram of an example LIDAR system 500, in accordance with various embodiments. In some embodiments, the LIDAR system 500 may be substantially similar to or incorporate features of the LIDAR system 100. For example, the LIDAR system 500 includes a transmitter 510, a receiver 520, and FPAs (including a first FPA 531 and a second FPA 532), which may be substantially similar to or incorporate features of the transmitter 310, the receiver 320, and the FPA 330. The LIDAR system 500 of FIG. 5 is simplified for illustrative purposes, and thus, can be implemented as any of various other configurations while remaining within the scope of the present disclosure. In some examples, the LIDAR system 500 can include more, fewer, or different components than shown in the figure.

As shown, the first FPA 531 can be included in and/or operatively coupled with the transmitter 510, while the second FPA 532 can be included in and/or operatively coupled with the receiver 520. The transmitter 510 can transmit an optical signal to an environment of the LIDAR system 500 through the first FPA 531. For example, a FMCW modulator of the transmitter 510 can receive an input signal from a laser source and configure the input signal for FMCW operation. The first FPA 531 can receive the input signal configured for FMCW operation and transmit the optical signal to the environment. For example, the first FPA 531 can transmit a first portion of the optical signal to a first corresponding area of the environment, and transmit a second portion of the optical signal to a second corresponding area of the environment. In some embodiments, the transmitter 510 can be configured to illuminate an entire scene of the environment of the LIDAR system 500. In some embodiments, the transmitter 510 can be configured to illuminate a selected scene of the environment of the LIDAR system 500, as discussed in greater detail below. The receiver 520 can receive a return signal from a target in the environment in response to transmitting the optical signal. The FPA 530 of the receiver 520 can be configured to receive the return signal. For example, each of a plurality of pixels in the FPA 530 can receive a corresponding portion of the return signal.

The FPAs disclosed herein can be configured to function as a focal plane select array (FPSA). In some embodiments, the first FPA 531 can be configured as a FPSA. In some embodiments, the second FPA 532 can be configured as a FPSA. In some embodiments, the transmitter 510 can be configured to transmit the optical signal (e.g., the FMCW signal) through selected one or more pixels of the first FPA 531 (e.g., at a time or sequentially). For example, the transmitter 510 can transmit the optical signal (e.g., the FMCW signal) through selected one or more pixels of the first FPA 531 to one or more corresponding scenes of the environment. In some embodiments, the receiver 520 can receive a return signal through selected one or more pixels of the second FPA 532 (e.g., at a time or sequentially). In some embodiments, the selected one or more pixels of the second FPA 532 can correspond to the selected one or more pixels of the first FPA 531. In some embodiments, one or more processors (described in greater detail below) can select the one or more pixels of the two-dimensional array of pixels of the first FPA 531, and control the transmitter 510 to transmit the FMCW signal through the selected one or more pixels. In some embodiments, one or more processors can select the one or more pixels of the two-dimensional array of pixels of the second FPA 532, and control the receiver 520 to receive the return signal through the selected one or more pixels.

In some embodiments, the LIDAR systems disclosed herein (e.g., the LIDAR system 500) can be operatively coupled with and/or include a computing system (not shown). The computing system includes one or more processors, one or more memory devices, etc. The one or more processors can execute instructions stored in the one or more memory devices. In some embodiments, the one or more processors may be any logic circuitry that processes instructions. In some embodiments, the one or more processors are microprocessor units or special purpose processors. The computing system may be based on any processor, or set of processors, capable of operating as described herein. The one or more processors may be single core or multi-core processors. The one or more processors may be multiple distinct processors. The one or more memory devices may be any device suitable for storing computer readable data. The one or more memory devices may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, Blu-Ray® discs, etc.). In some embodiments, the one or more processors can be configured to select the one or more pixels of the two-dimensional array of pixels (e.g., of the first FPA 531, the second FPA 532, etc.), based on a machine learning (ML) algorithm. For example, the one or more processors can apply the ML algorithm to select the one or more pixels of the two-dimensional array of pixels (e.g., of the first FPA 531, the second FPA 532, etc.). For example, one or more ML algorithms may be used to guide which transmitting and receiving pixel(s) to operate at a given time and determine a frequency to refresh one or more pixels (e.g., whether selected pixels corresponding to selected areas of the scene to be refreshed more often than others).

By transmitting/receiving an optical signal associated with an area of interest in an environment, rather than an optical signal for an entire scene of the environment, operating power can be reduced.

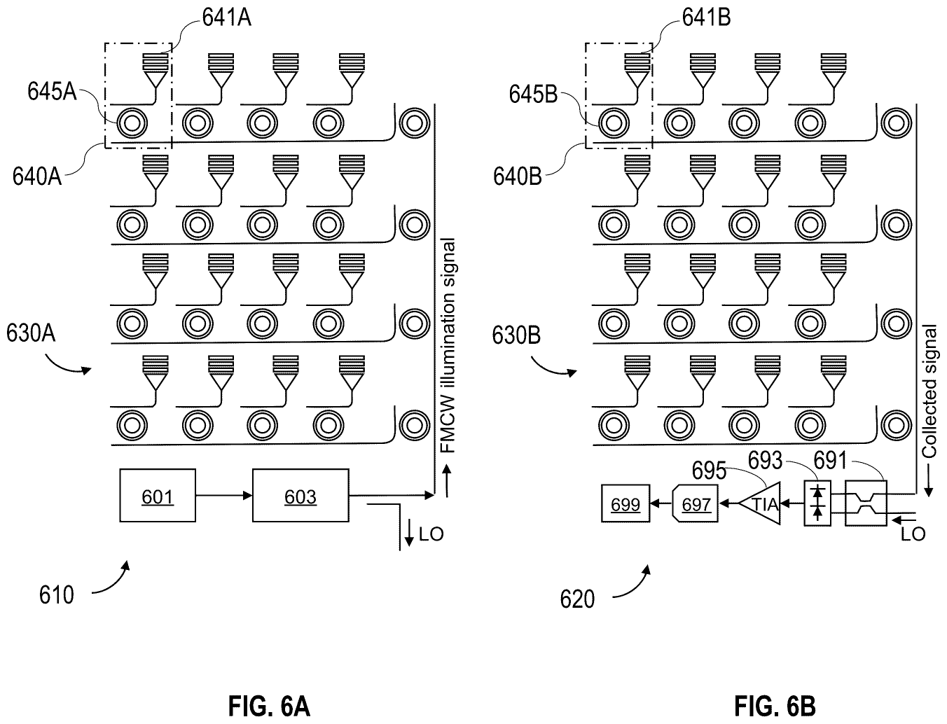

FIG. 6A illustrates a schematic diagram of an example transmitter 610 that can be included in a LIDAR system (e.g., the LIDAR systems 100, 200, 300, 500, etc.), in accordance with various embodiments. FIG. 6B illustrates a schematic diagram of an example receiver 620 that can be included in a LIDAR system (e.g., the LIDAR systems 100, 200, 300, 500, etc.), in accordance with various embodiments. In some embodiments, the transmitter 610 may be substantially similar to or incorporate features of the transmitters 110, 510, etc. In some embodiments, the receiver 620 may be substantially similar to or incorporate features of the receivers 120, 520, etc. For example, the transmitter 610 includes a first FPA 630A, which in some embodiments, may be substantially similar to or incorporate features of the FPA 130, 531, etc. The receiver 620 includes a second FPA 630B, which in some embodiments, may be substantially similar to or incorporate features of the FPA 130, 532, etc. The transmitter 610 and the receiver 620 in the figures are simplified for illustrative purposes, and thus, can be implemented as any of various other configurations while remaining within the scope of the present disclosure. In some examples, each of the transmitter 610 and the receiver 620 can include more, fewer, or different components than shown in the figure.

In some embodiments, the first FPA 630A may be an example of the first FPA 531. For example, the first FPA 630A can be included in or operatively coupled with the transmitter 510, which can be configured as a FPSA transmitter (and/or illuminator). In some embodiments, the second FPA 630B may be an example of the second FPA 532. For example, the second FPA 630B can be included in or operatively coupled with the receiver 520, which can be configured as a FPSA receiver (and/or collector).

In some embodiments, the first FPA 630A includes a plurality of first pixels 640A. In some embodiments, the second FPA 630B includes a plurality of second pixels 640B. In some embodiments, the first pixels 640A and the second pixels 640B can be substantially similar to or incorporate features of the pixels 440. For example, each of the first pixels 640A includes a light coupler 641A (e.g., similar to the light coupler 441). The light coupler 641A can be a grating coupler, a nanostructure configured as a light emitter, etc., in some examples. Each of the second pixels 640B includes a light coupler 641B (e.g., similar to the light coupler 441). The light coupler 641B can be a grating coupler, a nanostructure configured as a light collector, etc., in some examples.

In some embodiments, as shown, each of the first pixels 640A includes a first optical switch 645A. The first optical switch 645A can be or include a resonator, a microring resonator (MRR), any nanostructure or MEMS device configured to operate as a switch, etc., in some examples. In some embodiments, as shown, each of the second pixels 640B includes a second optical switch 645B. The second optical switch 645B can be or include a resonator, a microring resonator (MRR), etc., in some examples. The first optical switch 645A and the second optical switch 645B allows the first FPA 630A and the second FPA 630B to operate as an FPSA, respectively. In some embodiments, the first optical switch 645A may be omitted. In some embodiments, the second optical switch 645B may be omitted.

The optical switches disclosed herein (e.g., the optical switches 645A, 645B) can be included both in the transmitter 610 and the receiver 620 in various manners. In some embodiments, as shown, the optical switches can be integrated at the pixel level. In some embodiments, optical buses can be arranged to extend across rows and/or columns next to each pixel. In some embodiments, the optical switch may be an in-pixel switch (e.g., as shown) configured to route the signal from/to the corresponding pixel. The integration of the optical switches in the transmitter 610 and/or the receiver 620 allows for faster switching and faster frame rate, and operation of multiple simultaneous pixels. In this approach, one or more coherent receivers can be time-shared across the entire FPA (or FPSA) in the receiver 620.

In some embodiments, the optical switches may be double-bus MRRs. In this approach, a coupling ratio between the two waveguide buses can be an analog function of the resonant wavelength of the MRRs. This allows for the amount of optical signal routed to/from the pixels to the row/column waveguides to be continuously adjusted. For example, optical signals can be emitted from multiple pixels simultaneously.

In some embodiments, the transmitter 610 includes a laser 601. In some embodiments, the transmitter 610 includes a modulator 603. The laser 601 can generate an input signal. The modulator 603 can receive the input signal from the laser 601 and configure the input signal for FMCW operation. For example, the modulator 603 may be or include a FMCW modulator. The transmitter 610 can direct the modulated signal (e.g., FMCW illumination signal) to the first FPA 630A. In some embodiments, the transmitter 610 can direct a fraction of the modulated signal as a LO signal. The first FPA 630A can receive the modulated signal and transmit to the environment through the light coupler 641A. For example, the first FPA 630A can transmit a first portion of the modulated signal to a first corresponding area of the environment through a first light coupler of a first pixel, and transmit a second portion of the modulated signal to a second corresponding area of the environment through a second light coupler of a second pixel. In some embodiments, the transmitter 610 can be configured to illuminate an entire scene of the environment of the LIDAR system. In some embodiments, the transmitter 610 can be configured to illuminate a selected scene of the environment of the LIDAR system, based on operation of the first optical switch 645A. For example, each of the optical switches 645A in the plurality of first pixels 64A can be controlled to selectively activate or otherwise allow the respective pixel to transmit the modulated signal.

In some embodiments, the receiver 620 includes a receiver circuit, including a coupler 691, a photodetector 693, a TIA 695, an ADC 697, a FFT engine 699, etc. The second FPA 630B can receive a return signal from a target in the environment of the LIDAR system. The second FPA 630B can transmit the return signal to the receiver circuit. For example, the second FPA 630B can receive a first return signal from a first corresponding area of the environment through a first light coupler of a first pixel, and transmit the first return signal to the receiver circuit. The second FPA 630B can receive a second return signal from a second corresponding area of the environment through a second light coupler of a second pixel, and transmit the second return signal to the receiver circuit. In some embodiments, the coupler 691 can couple the return signal with the LO signal (e.g., from the transmitter 610) and combine into a combined optical signal. The photodetector 693 can then convert the combined optical signal into an electrical current, representing the intensity and phase information of the signal. This current can be amplified and converted to a voltage by the TIA 695, making it suitable for further processing. The ADC 697 can digitize the amplified signal, enabling precise analysis in the digital domain. Finally, the FFT engine 699 can process the digitized data to extract frequency components to determine the target's range and/or velocity.

As discussed herein, FPAs or FPSAs can be used both in the transmitter (e.g., the transmitter 610) and the receiver (e.g., the receiver 620). In some embodiments, one or more pixels (e.g., the pixel 640A) in the FPA 630A of the transmitter 610 can be configured to illuminate a specific region of the environment at any given time with the FMCW modulated light. In some embodiments, a corresponding pixel (or pixels) (e.g., the pixel 640B) in the FPA 630B of the receiver 620 can be configured to collect the return signal in a coherent scheme. In some embodiments, the one or more pixels in the transmitter 610 and the one or more pixels in the receiver 620 can be sequentially (or using another scheme) activated, turned on, or otherwise controlled to capture the entire scene.

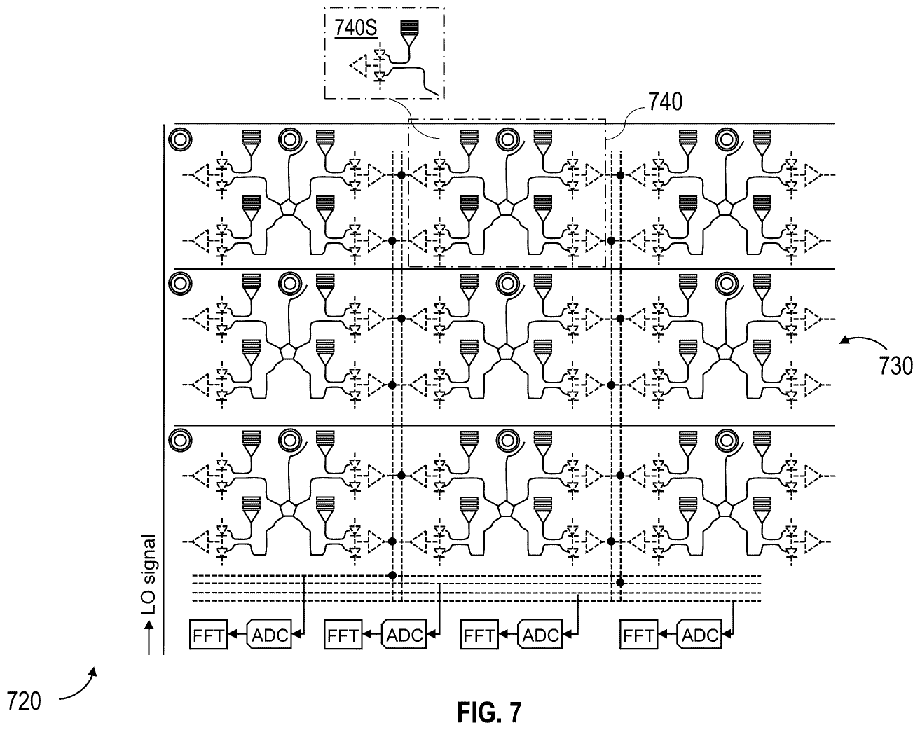

FIG. 7 illustrates a schematic diagram of an example receiver 720 that can be included in a LIDAR system (e.g., the LIDAR systems 100, 200, 300, 500, etc.), in accordance with various embodiments. In some embodiments, the receiver 720 may be substantially similar to or incorporate features of the receivers 120, 520, 620, etc. For example, the transmitter 710 includes a FPA 730, which in some embodiments, may be substantially similar to or incorporate features of the FPA 130, 532, 630A, etc. The receiver 720 in the figure is simplified for illustrative purposes, and thus, can be implemented as any of various other configurations while remaining within the scope of the present disclosure. In some examples, the receiver 720 can include more, fewer, or different components than shown in the figure.

As shown in FIG. 7, in some embodiments, each pixel of a plurality of pixels 740 (e.g., a two-dimensional array of pixels) includes a plurality of sub-pixels 740S. In some embodiments, each of the sub-pixels 740s can include a light coupler configured to transmit the FMCW signal or receive the return signal. In some embodiments, each of the sub-pixels 740S can include an optical switch (e.g., for FPSA operations), a photodetector, etc. In some embodiments, each of the sub-pixels 740S may be substantially similar to or incorporate features of the pixel 440, the pixel 640B, etc. Although shown to be included in a receiver, in some embodiments, sub-pixel configuration can be utilized in a transmitter. For example, the sub-pixel 740S may be substantially similar to or incorporate features of the pixel 640A (e.g., when configured as a pixel in a transmitter), and can be configured to transmit a FMCW signal in response to receiving an input signal from a laser, a FMCW modulator, etc.

A return signal received from multiple adjacent sub-pixels (e.g., sub-pixels 740S) can improve sensitivity at a lower resolution. This can be achieved electronically at the hardware and/or software level. For hardware-level implementation, analog signals from multiple sub-pixels can be combined (e.g., summing TIA output currents) prior to digitization using the ADC. The FPA (or FPSA) architecture discussed herein enables concurrent operation of groups of adjacent sub-pixels. Each receiving pixel can include the frontend of the coherent receiver, such as the light coupler, the balanced photodetector, TIA, etc., with the LO signal selectively routed to one or more pixels 740 (and/or one or more groups of the sub-pixels 740S) using the optical switches. Analog electronic signals from these pixel groups can then be routed to the edges of the FPA 730, where the rest of the coherent receiver, including the ADC and FFT, can be time-shared. In some embodiments, signals from multiple pixels can be processed collectively without performing FFT on each pixel individually. In some embodiments, the receiver 720 can include a plurality of receiver circuits (e.g., the ADC, FFT, etc.), which can be operatively coupled with a plurality of respective columns (or a plurality of respective rows) in the pixel array.

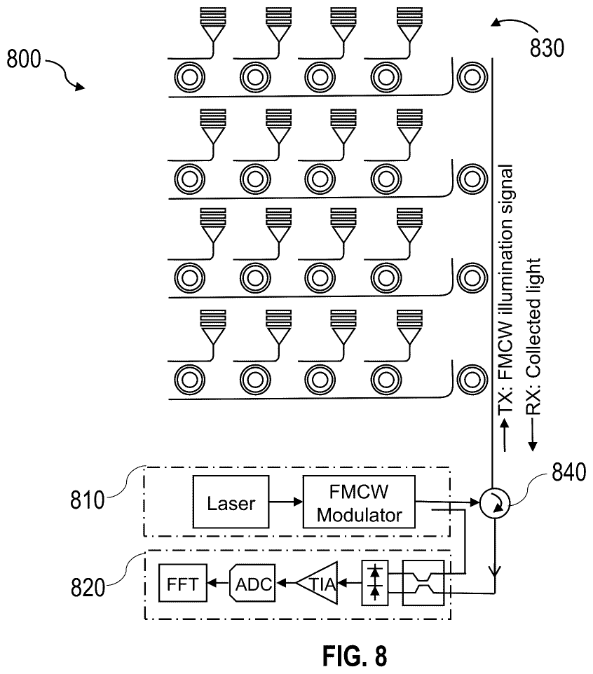

FIG. 8 illustrates a schematic diagram of an example LIDAR system 800, in accordance with various embodiments. In some embodiments, the LIDAR system 800 may be substantially similar to or incorporate features of the LIDAR systems 100, 200, 300, 500, etc. For example, the LIDAR system 800 includes a transmitter 810, a receiver 820, and an FPA 830, which may be substantially similar to or incorporate features of the transmitter 110, the receiver 120, and the FPA 130, etc. The LIDAR system 800 in the figure is simplified for illustrative purposes, and thus, can be implemented as any of various other configurations while remaining within the scope of the present disclosure. In some examples, the LIDAR system 800 can include more, fewer, or different components than shown in the figure.

The FPA disclosed herein can be coupled to a receiver, a transmitter, or both. In some embodiments, as discussed above, each of the receiver and the transmitter is coupled with and/or includes a respective FPA. Referring to FIG. 8, in some embodiments, the LIDAR system 800 includes a single FPA 830 coupled to the transmitter and the receiver. The FPA 830 can be configured such that the transmitter 810 can transmit an optical signal (e.g., FMCW illumination signal) to an environment through the FPA 830, and that the receiver 820 can receive a return signal through the FPA 830. That is, the single FPA 830 can be configured to function as both a transmitting FPA and a receiving FPA.

In some embodiments, the FPA 830 can be configured to function as a FPSA. The FPA 830 can be controlled to transmit the FMCW signal through selected one or more pixels (e.g., selected by one or more processors of the LIDAR system). The FPA 830 can be controlled to receive the return signal through the selected one or more pixels. In some embodiments, the LIDAR system 800 may include an optic 840, etc. configured to couple the FPA 830 to the transmitter 810 (e.g., routing the FMCW illumination signal from the transmitter 810 to the FPA 830) when the LIDAR system 800 transmits the optical signal, and couple the FPA 830 to the receiver 820 (e.g., directing the received collected light from the FPA 830 to the receiver 820) when the LIDAR system 800 receives the return light. The optic 840 may be or include, but not limited to, a lens, a circulator, or any optics configured to control the direction of light flow. In some embodiments, the LIDAR system 800 includes a primary lens (not shown). The FPA 830 can operate both in transmitting and receiving modes based on operation of the primary lens. In some embodiments, each of the plurality of pixels in the FPA 830 can include a microlenses. This can further enhance the light illumination/collection efficiency.

In some embodiments, as shown, each of the plurality of pixels in the FPA 830 can include a light coupler (e.g., a nanostructure, a grating structure, etc., configured to serve as both a light illuminator (transmitting) and a light collector (receiving)). In some embodiments, as shown, each of the plurality of pixels in the FPA 830 can include an optical pixel-select switch (e.g., a resonator, an MRR, any nanostructure or MEMS device configured to operate as a switch). In some embodiments, one or more components of the LIDAR system 800 can be time shared across the FPA 830 (or FPSA). The optic 840 (e.g., an optical circulator, a directional coupler, etc.) may be used to separate the transmitting and receiving paths. In some embodiments, the receiving path can include a photodetector, a TIA, an ADC, a FFT engine, etc. In some embodiments, ML algorithms can be used to guide the sequence, illumination, and integration time of selected (activated) pixels. In this approach, the FMCW modulated optical signal (e.g., in the transmitting path) and the local oscillator (LO) path (e.g., in the coherent receiving path) can be collocated.

As discussed above, in some embodiments, the LIDAR systems disclosed herein can include one or more processors, while the FPA can include a circuit (e.g., a control circuit, an in-processing circuit in each of a plurality of pixels of the FPA, etc.). The one or more processors can be configured to control the circuit.

In some embodiments, the FPA 830 can be configured to selectively couple with the transmitter 810 or the receiver 820 through the optic 840. The one or more processors can be configured to control the optic 840 to couple the FPA 830 to the transmitter 810 when the LIDAR system 800 transmits the optical signal, and to couple the FPA 830 to the receiver 820 when the LIDAR system 800 receives the return signal. In some embodiments, the one or more processors can be configured to control the optic 840 to couple the FPA 830 to the transmitter 810 when the LIDAR system 800 transmits the FMCW signal. In some embodiments, the one or more processors can be configured to control the optic 840 to couple the FPA 830 to the receiver 820 when the LIDAR system 800 receives the return signal. In some embodiments, the one or more processors can be configured to select one or more pixels of the two-dimensional array of pixels. The circuit can be configured to selectively activate the selected one or more pixels to transmit the FMCW signal or receive the return signal. In some embodiments, the one or more processors can be configured to control the circuit for the transmitter 810 to transmit the FMCW signal through the selected one or more pixels of the FPA 830. In some embodiments, the one or more processors can be configured to control the circuit for the receiver 820 to receive the return signal through the selected one or more pixels of the FPA 830. In some embodiments, the one or more processors are configured to select the one or more pixels based on a machine learning model that provides an output indicating which pixels operate at a given time.

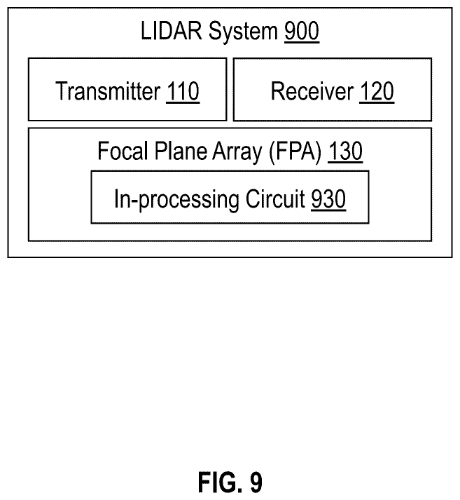

FIG. 9 illustrates a block diagram of an example LIDAR system 900, in accordance with various embodiments. In some embodiments, the LIDAR system 900 may be substantially similar to or incorporate features of the LIDAR systems 100, 200, 300, 500, 800, etc. For example, the LIDAR system 900 additionally includes an in-processing circuit 930 as opposed to the LIDAR system 100. The LIDAR system 900 in the figure is simplified for illustrative purposes, and thus, can be implemented as any of various other configurations while remaining within the scope of the present disclosure. In some examples, the LIDAR system 900 can include more, fewer, or different components than shown in the figure.

In some embodiments, the LIDAR system 900 includes a circuit included in the FPA 130. In some embodiments, each of a plurality of pixels in the FPA 130 can be operatively coupled with or include the in-processing circuit 930. For example, each of a plurality of in-processing circuits 930 can be included in a corresponding one of the plurality of pixels (e.g., the two-dimensional array of pixels). In some embodiments, every sub-group of the plurality of pixels in the FPA 130 can be operatively coupled with or include the in-processing circuit 930. The circuit (e.g., the in-processing circuit 930) can be configured to control each of the plurality of pixels (e.g., a two-dimensional array of pixels) to transmit an FMCW signal to an environment through the plurality of pixels. The circuit can be configured to control each of the plurality of pixels (e.g., the two-dimensional array of pixels) to receive a return signal through the plurality of pixels.

In some embodiments, the in-processing circuit 930 can be configured to control the corresponding pixel to transmit the FMCW signal. In some embodiments, the in-processing circuit 930 can be configured to control the corresponding pixel to receive the return signal. In some embodiments, the in-processing circuit 930 can include, but not limited to, a receiver circuit, a TIA, an ADC, a FFT engine, etc.

In some embodiments, each of the plurality of pixels of the FPA 130 can include an optical switch configured to activate a corresponding one of the plurality of pixels of the FPA 130 to transmit the FMCW signal or to receive the return signal. Each of the in-processing circuits 930 can include control circuitry configured to set a resonance wavelength of the optical switch. In some embodiments, the in-processing circuit 930 can be configured to control the corresponding pixel to transmit the FMCW signal based on the resonance wavelength of the optical switch. In some embodiments, the in-processing circuit 930 can be configured to control the corresponding pixel to receive the return signal based on the resonance wavelength of the optical switch.

In some embodiments, each of the plurality of pixels includes a plurality of sub-pixels (e.g., as shown in FIG. 7), each of which including a light coupler configured to transmit the FMCW signal or receive the return signal. The in-processing circuit 930 can be configured to control the plurality of sub-pixels included in a corresponding one of the plurality of pixels. For example, every four pixels of the FPA 730 can include the in-processing circuit 930, which can control the corresponding group of pixels to transmit the FMCW signal or receive the return signal.

As discussed in greater detail below, in some embodiments, the FPAs can be integrated within a semiconductor substrate (e.g., silicon, etc.). For example, the FPA 130 can be part of silicon PIC. In some embodiments, the circuit (e.g., the in-processing circuit 930) in the FPA can be configured to operatively couple with a corresponding portion of a Complementary Metal-Oxide-Semiconductor (CMOS) circuit. The CMOS circuit can control each of the plurality of pixels of the FPA 130 through the coupling between the in-processing circuit 930 and the corresponding portion of the CMOS circuit.

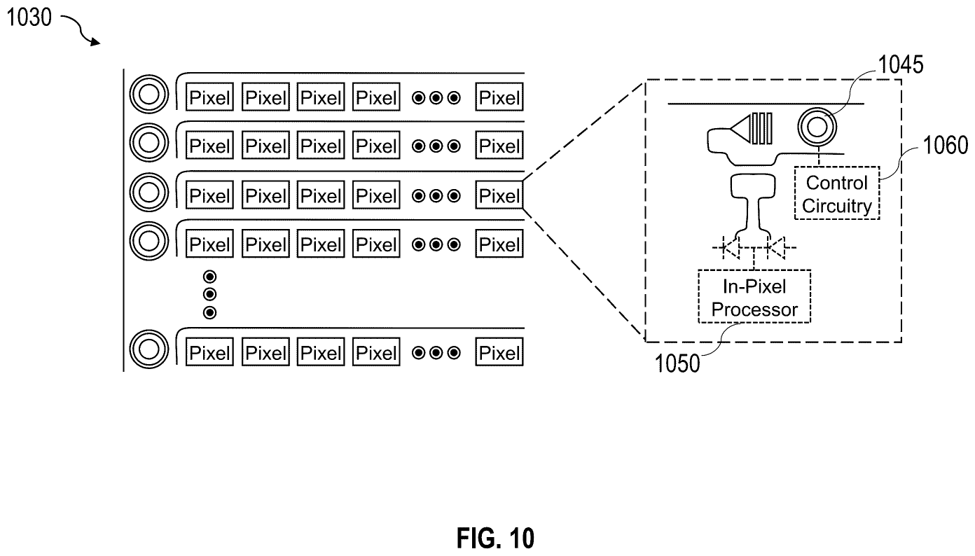

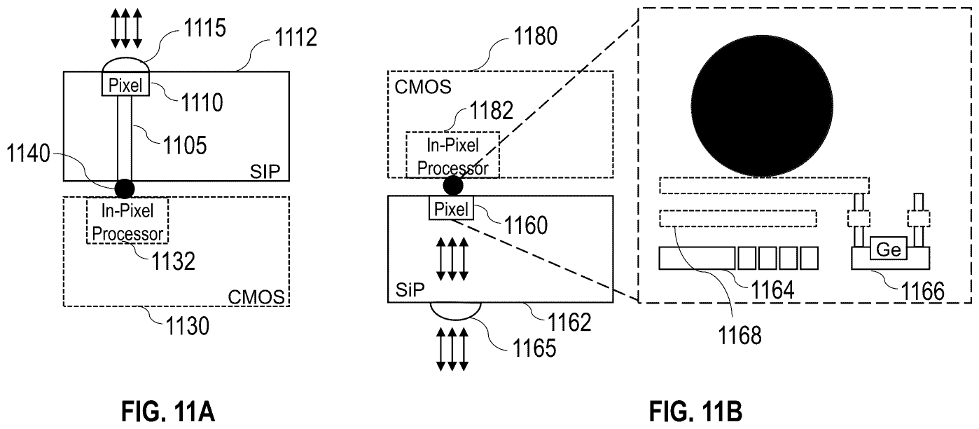

With the foregoing in mind, the figures and description below (e.g., FIG. 10, FIG. 11A, FIG. 11B, etc.) illustrate examples of the LIDAR systems including in-processing circuits. It should be noted that the figures and description below are non-limiting examples and can be implemented as any of various other configurations while remaining within the scope of the present disclosure.

FIG. 10 illustrates a schematic diagram of an example FPA 1030 that can be included in a LIDAR system (e.g., the LIDAR systems 100, 200, 300, 500, 800, 900, etc.), in accordance with various embodiments. The FPA 1030 of FIG. 10 is simplified for illustrative purposes, and thus, can be implemented as any of various other configurations while remaining within the scope of the present disclosure. In some examples, the FPA 1030 can include more, fewer, or different components than shown in the figure.

In some embodiments, as shown, each pixel of a plurality of pixels in the FPA 1030 can include an in-processing circuit. In some embodiments, the in-processing circuit can be configured to control each pixel to transmit the FMCW signal. In some embodiments, the in-processing circuit can be configured to control each pixel to receive the return signal. In some embodiments, the in-processing circuit may include an in-pixel processor 1050 and control circuitry 1060. In some embodiments, the in-pixel processor 1050 can include a receiver circuit (e.g., the receiver circuit 453), including but not limited to a transimpedance amplifier (TIA), an analog-to-digital converter (ADC), a Fast Fourier Transform (FFT) engine, etc. In some embodiments, the control circuitry 1060 can include a driving circuit and/or a controller configured to set a resonance wavelength of an optical switch 1045. In some embodiments, the in-processing circuit of each of the plurality of pixels in the FPA 1030 can include a transceiver.

The integration of the in-processing circuit within the FPA can be achieved in a commercial foundry silicon photonics process. In some embodiments, the in-processing circuit includes one or more transistors (e.g., fabricated using a SiP process, etc.). The advantage of this approach is the integration of electronics within each pixel, incorporating resonators (e.g., MRRs) in a large-scale FPA. Furthermore, in-pixel analog and mixed-signal can be implemented using CMOS transistor technologies.

FIG. 11A illustrates a schematic diagram of an example LIDAR system, in accordance with various embodiments. Specifically, part of the LIDAR system, including an example pixel 1110 coupled with an example circuit 1130, is shown. The pixel 1110, the circuit 1130, etc. shown in the figure are simplified for illustrative purposes, and thus, can be implemented as any of various other configurations while remaining within the scope of the present disclosure. In some examples, more, fewer, or different components than shown in the figure can be included.

In some embodiments, the FPA can be integrated within a substrate 1112. For example, a plurality of pixels (e.g., including the pixel 1110) of the FPA can be integrated within the substrate 1112. The substrate 1112, in some embodiments, may be a silicon substrate fabricated using a SiP process, a silicon photonic integrated circuit, etc. In some embodiments, the substrate 1112 can be operatively coupled with a Complementary Metal-Oxide-Semiconductor (CMOS) circuit 1130. For example, as shown, the substrate 1112 can be coupled with the CMOS circuit 1130 through one or more bump structures 1140. The CMOS circuit 1130 includes a plurality of processors 1132 (e.g., an in-pixel processor). Each of the plurality of processors 1132 can be configured to control a corresponding one of the plurality of pixels (e.g., the pixel 1110). For example, the in-pixel processor 1132 can be configured to control the pixel 1110 to transmit the FMCW signal and/or receive the return signal. The pixel 1110, in some embodiments, can include a light coupler, a photodetector, a receiver circuit, etc. The in-pixel processor 1132 can be configured to control the light coupler, the photodetector, the receiver circuit, etc. Referring to FIG. 11A, the pixel 1110 can be configured to transmit the FMCW signal and/or receive the return signal through a front side of the substrate 1112. In some embodiments, the pixel 1110 can be configured to transmit the FMCW signal and/or receive the return signal through a lens 1115. In some embodiments, as shown, the in-pixel processor 1132 can be coupled with the pixel 1110 through a through silicon via (TSV) 1105. For example, the plurality of processors of the CMOS circuit 1130 can be operatively coupled to the plurality of respective in-processing circuits of the plurality of pixels 1110 through the respective via structures 1105. In some embodiments, as shown, the via structures 1105 can extend in a thickness direction of the substrate 1112. In some embodiments, the via structure 1105 may be a through silicon via (TSV) structure. This enables the integration of the FPA with a CMOS chip by stacking the substrate, circuits, etc., thereby improving the device density. As shown, in some embodiments, the substrate 1112 can include the lens (e.g., a microlens) 1115 on a front side of the substrate 1112 such that the FPA can transmit the optical signal or receive the return signal through the lens 1115.

FIG. 11B illustrates a schematic diagram of an example LIDAR system, in accordance with various embodiments. Specifically, part of the LIDAR system, including an example pixel 1160 coupled with an example circuit 1180, is shown. The pixel 1160, the circuit 1180, etc. shown in the figure are simplified for illustrative purposes, and thus, can be implemented as any of various other configurations while remaining within the scope of the present disclosure. In some examples, more, fewer, or different components than shown in the figure can be included.

In some embodiments, the FPA can be integrated within a substrate 1162. For example, a plurality of pixels (e.g., including the pixel 1160) of the FPA can be integrated within the substrate 1162. The pixel 1160, in some embodiments, can include a light coupler 1164 (e.g., a grating coupler, a silicon coupler, a nanostructure, etc.), a photodetector 1166, a reflector 1168 (e.g., a nanostructure, an anti-reflection coating, matching layers between the backside of the substrate 1162 and a lens 1165), etc. In some embodiments, the substrate 1162 can include the lens (e.g., a microlens) 1165 on a front side of the substrate 1162 such that the FPA can transmit the optical signal or receive the return signal through the lens 1165.

The substrate 1162, in some embodiments, may be a silicon substrate fabricated using a SiP process, a silicon photonic integrated circuit, etc. In some embodiments, the substrate 1162 can be operatively coupled with a Complementary Metal-Oxide-Semiconductor (CMOS) circuit 1180. For example, as shown, the substrate 1162 can be coupled with the CMOS circuit 1180 through one or more bump structures. The CMOS circuit 1180 includes a plurality of processors 1182 (e.g., an in-pixel processor). Each of the plurality of processors 1182 can be configured to control a corresponding one of the plurality of pixels (e.g., the pixel 1160). For example, the in-pixel processor 1182 can be configured to control the pixel 1160 to transmit the FMCW signal and/or receive the return signal. The in-pixel processor 1182 can be configured to control the pixel 1160. Referring to FIG. 11B, the pixel 1160 can be configured to transmit the FMCW signal and/or receive the return signal through a back side of the substrate 1162. The light coupler 1164 can be configured to transmit the FMCW signal and/or receive the return signal through the substrate 1162. The reflector 1168 (e.g., a metal reflector) can be configured to reflect the light toward the back side of the substrate 1162 such that the light that reaches the reflector 1168 can be reflected to the backside of the substrate 1162, thereby reducing the light directed upwards. This improves the coupling efficiency of the laser signal in and out of the LIDAR system at each pixel. In some embodiments, the pixel 1160, the in-pixel processor 1182, etc. includes one or more transistors to facilitate control of the light.

The LIDAR systems disclosed herein can include various features, components, arrangement thereof, etc. without departing from the spirit or scope of the subject matter presented here. For example, the LIDAR systems can include grating emitters, collectors, microring resonators, power combiners, splitters, waveguide crossings, or any nanophotonic components. In some embodiments, grating couplers can be designed to couple light efficiently between an optical fiber and on-chip silicon waveguides, and similar structures can be utilized to couple light between air and on-chip silicon waveguides. These grating structures may have a limited field of view; however, the grating emitters and collectors disclosed herein can be designed to operate over a wide field of view. Additionally, micro-lenses can be co-designed with the grating emitters and collectors to control the entire optical path. Microring resonators can incorporate a thermo-optic phase modulator section to align the structure to resonance in the presence of process and temperature variations, as well as a carrier-depletion phase modulator section to adjust the resonant wavelength and enable switching. Algorithms can be developed to align microring resonators to resonance.

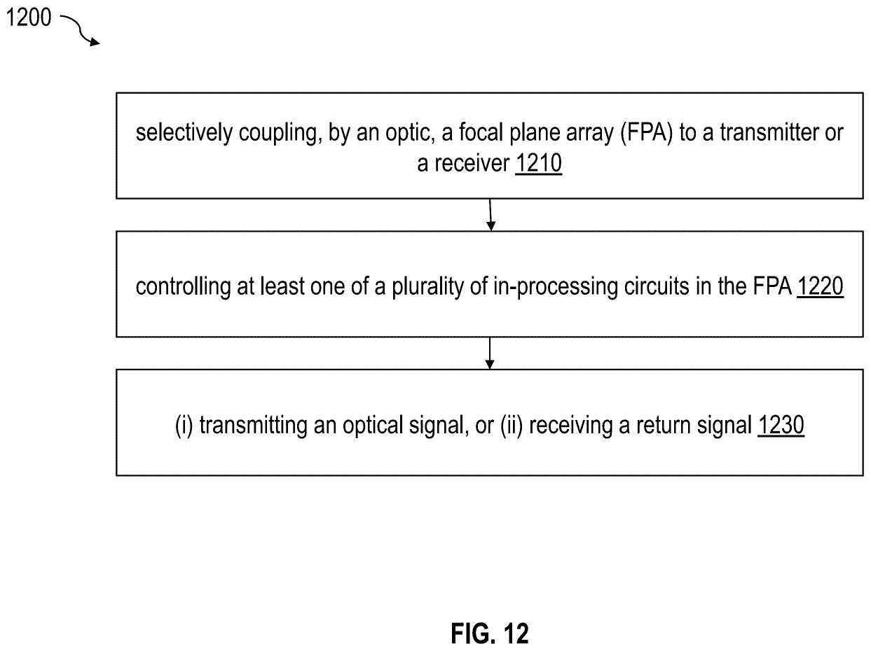

FIG. 12 illustrates a flow chart of an example method 1200 for LIDAR, in accordance with various embodiments. At least one of operations in the method 1200 can be used to operate a LIDAR system (e.g., the LIDAR system 100) or at least a portion thereof. It is noted that the method 1200 is a non-limiting example. Accordingly, it should be understood that additional operations may be provided before, during, and/or after the method 1200 of FIG. 1200, and that some other operations may only be briefly described herein. In some embodiments, the method 1200 can include more, fewer, or different operations than shown in FIG. 12.

In a brief overview, the method 1200 begins with operation 1210 of selectively coupling, by an optic, a focal plane array (FPA) to a transmitter or a receiver, the FPA including a plurality of pixels, each of which includes a corresponding one of a plurality of in-processing circuits. The method 1200 continues to operation 1220 of controlling at least one of the plurality of in-processing circuits in the FPA. The method 1200 continues to operation 1230 of in response to controlling the at least one of the plurality of in-processing circuits, at least one of: (i) transmitting, by the transmitter, an optical signal to an environment of a LIDAR system, and (ii) receiving, by the receiver, from a target in the environment, a return signal.

At operation 1210, the method 1200 can include selectively coupling a focal plane array (FPA) (e.g., the FPA 130) to a transmitter (e.g., the transmitter 110) or a receiver (e.g., the receiver 120). In some embodiments, the method 1200 can include selectively coupling, by an optic (e.g., the optic 840), the FPA to the transmitter or the receiver. The FPA includes a plurality of pixels, and each of the plurality of pixels can include a corresponding one of a plurality of in-processing circuits (e.g., the in-processing circuit 930).

At operation 1220, the method 1200 can include controlling at least one of the plurality of in-processing circuits in the FPA. In some embodiments, the method 1200 can include controlling an optical switch (e.g., the optical switches 645A, 645B, etc.) to activate a corresponding one of the plurality of pixels in the FPA.

At operation 1230, the method 1200 can include, at least one of: (i) transmitting an optical signal, or (ii) receiving a return signal. In some embodiments, the method 1200 includes transmitting the optical signal, by the transmitter, the optical signal to an environment of the LIDAR system in response to controlling the at least one of the plurality of in-processing circuits. For example, the transmitter (e.g., the transmitter 110) can transmit the FMCW signal to the environment of the LIDAR system (e.g., the LIDAR system 100). In some embodiments, the method 1200 includes receiving the return signal, by the receiver, the return signal in response to controlling the at least one of the plurality of in-processing circuits. For example, the receiver (e.g., the receiver 120) can receive the return signal from the target in the environment.

In some embodiments, the method 1200 includes coupling the optic to the transmitter (e.g., at operation 1210). The method 1200 can include setting a resonance wavelength of an optical switch of the FPA (e.g., at operation 1220). The method 1200 includes transmitting, by the transmitter, the optical signal to the environment of the LIDAR system based on the resonance wavelength of the optical switch (e.g., at operation 1230).

In some embodiments, the method 1200 includes coupling the optic to the receiver (e.g., at operation 1210). The method 1200 includes receiving, by the receiver, the return signal (e.g., operation 1230). The method 1200 can further include processing, by at least one of the plurality of in-processing circuits, the return signal, in response to receiving the return signal. For example, the method 1200 can include controlling a circuit (e.g., a control circuit, the in-processing circuit, etc.) to operate a photodetector, a TIA, an ADC, a FFT engine, etc.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A Light Detection and Ranging (LIDAR) system comprising:
a transmitter configured to transmit a frequency modulated continuous wave (FMCW) signal;
a receiver configured to receive, from a target, a return signal in response to transmitting the FMCW signal;
a focal plane array (FPA) coupled to at least one of the transmitter and the receiver, the FPA including a two-dimensional array of pixels; and
a circuit included in the FPA and configured to control each of the two-dimensional array of pixels to at least one of: (i) transmit the FMCW signal through the two-dimensional array of pixels and (ii) receive the return signal through the two-dimensional array of pixels.

2. The LIDAR system of claim 1, wherein the circuit includes a plurality of in-processing circuits, each of which is included in a corresponding one of the two-dimensional array of pixels.

3. The LIDAR system of claim 2, wherein each of the in-processing circuits includes a receiver circuit including a transimpedance amplifier (TIA), an analog-to-digital converter (ADC), and a Fourier Transform engine.

4. The LIDAR system of claim 2,
wherein each of the two-dimensional array of pixels includes an optical switch configured to activate a corresponding one of the two-dimensional array of pixels to transmit the FMCW signal or to receive the return signal.

5. The LIDAR system of claim 4, wherein the optical switch includes a micro-ring resonator, and each of the in-processing circuits includes control circuitry configured to set a resonance wavelength of the optical switch.

6. The LIDAR system of claim 2,
wherein the FPA is integrated within a semiconductor substrate and operatively coupled with Complementary Metal-Oxide-Semiconductor (CMOS) circuits, the CMOS circuits configured to realize the plurality of in-processing circuits, and
wherein the FPA is configured to transmit the FMCW signal or receive the return signal through a front side or a back side of the substrate.

7. The LIDAR system of claim 6,
wherein the FPA is configured to transmit the FMCW signal or receive the return signal through the front side of the semiconductor substrate, and the CMOS circuits are operatively coupled to the pixels through respective via structures extending in a thickness direction of the semiconductor substrate, or
wherein the FPA is configured to transmit the FMCW signal or receive the return signal through the back side of the semiconductor substrate, and each of the plurality of pixels includes a grating coupler, a photodetector, and a reflector configured to reflect light toward the back side of the semiconductor substrate.

8. The LIDAR system of claim 1, further comprising one or more processors configured to:
control the circuit for the transmitter to transmit the FMCW signal through selected one or more pixels of the FPA; and
control the circuit for the receiver to receive the return signal through the selected one or more pixels of the FPA.

9. The LIDAR system of claim 8, further comprising an optic configured to couple the FPA to the transmitter when the LIDAR system transmits the FMCW signal and couple the FPA to the receiver when the LIDAR system receives the return signal, wherein the one or more processors are configured to select one or more pixels of the two-dimensional array of pixels, and the circuit is configured to selectively activate the selected one or more pixels to transmit the FMCW signal or receive the return signal.

10. The LIDAR system of claim 9, wherein the one or more processors are configured to select the one or more pixels based on a machine learning model that provides an output indicating which pixels operate at a given time.

11. The LIDAR system of claim 1,
wherein each of the two-dimensional array of pixels includes a plurality of sub-pixels, each of which including a light coupler configured to transmit the FMCW signal or receive the return signal, and
wherein the circuit includes a plurality of in-processing circuits, each of which is included in a corresponding one of the two-dimensional array of pixels and configured to control the plurality of sub-pixels included in the corresponding one of the two-dimensional array of pixels.

12. The LIDAR system of claim 11, further comprising an optical switch configured to select the plurality of sub-pixels.

13. A Light Detection and Ranging (LIDAR) system comprising:
a transmitter configured to transmit an optical signal;
a receiver configured to receive, from a target, a return signal in response to transmitting the optical signal;
a focal plane array (FPA) configured to selectively couple with the transmitter or the receiver through an optic; and
one or more processors configured to control the optic to couple the FPA to the transmitter when the LIDAR system transmits the optical signal, and to couple the FPA to the receiver when the LIDAR system receives the return signal.

14. The LIDAR system of claim 13, further comprising a plurality of in-processing circuits, each of which is included in a corresponding one of a plurality of pixels of the FPA,
wherein the one or more processors are configured to control each of the plurality of in-processing circuits to control the corresponding one of the plurality of pixels of the FPA to transmit the optical signal or receive the return signal.

15. The LIDAR system of claim 13,
wherein the FPA is integrated within a semiconductor substrate, and the semiconductor substrate is connected to a Complementary Metal-Oxide-Semiconductor (CMOS) circuit through one or more bump structures.

16. The LIDAR system of claim 15,
wherein the semiconductor substrate includes a microlens on a front side or a back side of the substrate, and the FPA is configured to transmit the optical signal or receive the return signal through the microlens.

17. The LIDAR system of claim 13, wherein the optical signal is a frequency modulated continuous wave (FMCW).

18. A method for Light Detection and Ranging (LIDAR), the method comprising:
selectively coupling, by an optic, a focal plane array (FPA) to a transmitter or a receiver, the FPA including a plurality of pixels, each of which includes a corresponding one of a plurality of in-processing circuits;
controlling at least one of the plurality of in-processing circuits in the FPA; and
in response to controlling the at least one of the plurality of in-processing circuits, at least one of: (i) transmitting, by the transmitter, an optical signal to an environment of a LIDAR system, and (ii) receiving, by the receiver, from a target in the environment, a return signal.

19. The method of claim 18, further comprising:
coupling the optic to the transmitter;
setting a resonance wavelength of an optical switch of the FPA; and
transmitting, by the transmitter, the optical signal based on the resonance wavelength of the optical switch.

20. The method of claim 18, further comprising:
coupling the optic to the receiver;
receiving, by the receiver, the return signal; and
processing, by at least one of the plurality of in-processing circuits, the return signal, in response to receiving the return signal.
